(19) United States
(12) Patent Application Publication
(10) Pub. No.: US 2013/0078034 A1
(43) Pub. Date: Mar. 28, 2013

(54) BUILDING BLOCK

(71) Applicant: Konstantinos Kapelonis, Whitestone, NY (US)

(72) Inventor: Konstantinos Kapelonis, Whitestone, NY (US)

(21) Appl. No.: 13/246,029

(22) Filed: Sep. 27, 2011

(51) Int. Cl. F16B 7/18

(52) U.S. Cl. 403/343

(57) ABSTRACT

Disclosed is a building block having a body, a stud and a cavity. The stud and cavity have threaded surfaces, allowing blocks to be rotated together to form a secure structure. Specifically, the stud of one block may be inserted and rotated into the cavity of another block, providing a secure connection between the two blocks. The blocks may be separated by rotation in the reverse direction.

### FIELD OF THE INVENTION

The present invention generally relates to blocks, and more specifically, building blocks. According to the invention, a block comprises a protruding stud and a receiving cavity. The stud has a threaded surface, and the cavity has a threaded inner wall, allowing two or more blocks to be joined together to form a structure.

### BACKGROUND OF THE INVENTION

Existing building blocks come in varying shapes and feature different methods of attachment. Some blocks, such as those produced by The LEGO Group and MEGA Brands, Inc., have smooth studs and smooth hollow cavities which allow the blocks to be snapped together. The interlocking blocks may be separated simply by being pulled apart. As another example, U.S. Pat. No. 1,531,542 describes building blocks with cylindrical extension bars and complementary grooves adapted to receive the bars. The blocks may be attached and separated by sliding the blocks alongside each other.

There is a need for a new and improved block that is capable of being more firmly attached to other blocks. Similarly, there is a need for a new and improved block that, when attached to other blocks, forms a more stable structure.

### SUMMARY OF THE INVENTION

Disclosed is a building block with a body, a protruding stud and cavity within the body. The stud has a threaded surface, and the cavity has a threaded wall. When the stud of one block is inserted into the cavity of another block and rotated, the threaded surfaces cause the two blocks to securely join together.

It is an object of the present invention to provide a block that may be securely attached to one or more other blocks. Similarly, it is an object of the present invention to provide a block that, when attached to one or more other blocks, forms a secure and stable structure.

### BRIEF DESCRIPTION OF THE DRAWINGS

A further understanding of the present invention can be obtained by reference to a preferred embodiment set forth in the illustrations of the accompanying drawings. The illustrated embodiment is merely exemplary of a means for accomplishing the present invention. Further objectives and advantages thereof may be more easily understood by reference to the drawings and the following description. The drawings are not intended to limit the scope of this invention, which is set forth with particularity in the claims as appended or as subsequently amended, but merely to clarify and exemplify the invention.

FIG. 1 is a perspective view of a prior art block.

FIG. 2 is a perspective view of a block according to the present invention.

FIG. 3 is a side view of a block according to the present invention.

FIG. 4 is a top view of a block according to the present invention.

FIG. 5 is a bottom view of a block according to the present invention.

FIG. 6 is a perspective view of two connected blocks according to the present invention.

FIG. 7 is a perspective view of a round block according to an alternate embodiment of the present invention.

FIG. 8 is a perspective view of a hexagonal block according to an alternate embodiment of the present invention.

FIG. 9 is a block according to an alternate embodiment of the present invention featuring a two-tiered body.

FIG. 10 is a block according to an alternate embodiment of the present invention featuring two studs and two cavities.

FIG. 11 is the top view of a block according to an alternate embodiment of the present invention featuring a hole through the center of the block.

FIG. 12 is the bottom view of a block according to an alternate embodiment of the present invention featuring a hole through the center of the block.

FIG. 13 is a perspective view of a block according to an alternate embodiment of the present invention featuring a hole through the center of the block.

### DETAILED DESCRIPTION OF THE PREFERRED EMBODIMENT

A detailed illustrative embodiment of the present invention is disclosed herein. However, structures and techniques in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

None of the terms used herein, including “body”, “stud” and “cavity” are meant to limit the application of the invention. The terms are used for convenience and are not intended to limit the scope of the invention. Similarly, the use of the term “block” is not meant to limit the scope of the invention to one type of physical embodiment, as any tangible apparatus can also utilize the present invention. The following presents a detailed description of a preferred embodiment of the present invention.

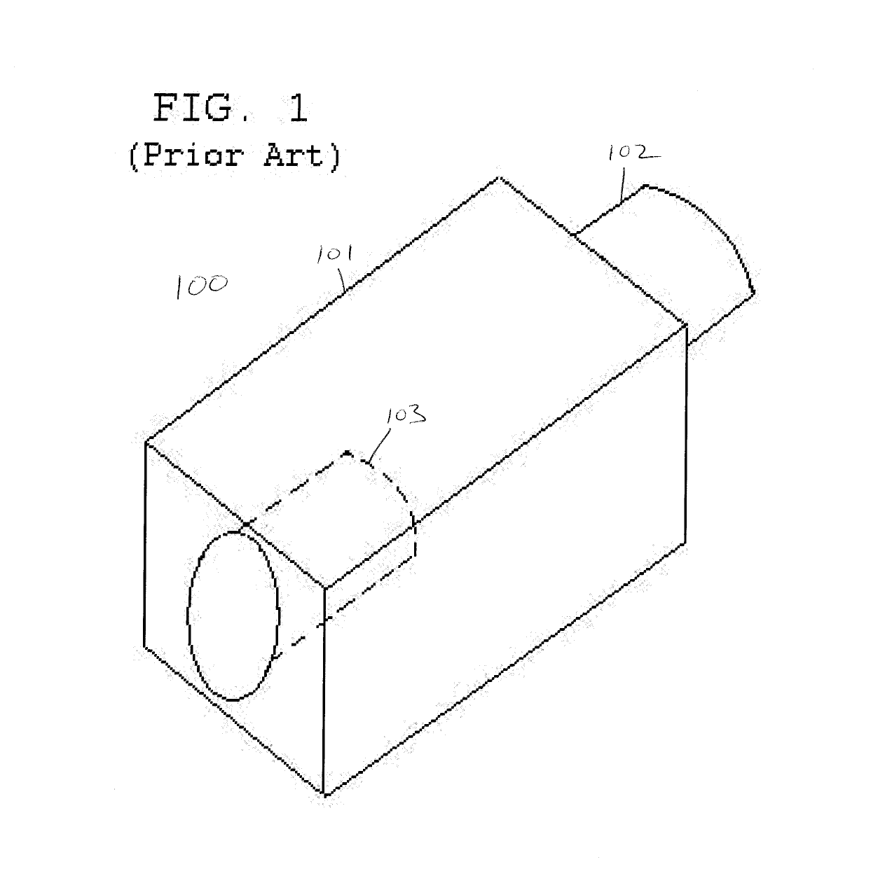

Referring to FIG. 1, depicted is a prior art block 100 comprising body 101, stud 102 and cavity 103. Traditionally, the stud of one block may be inserted into the cavity of another block to form a structure.

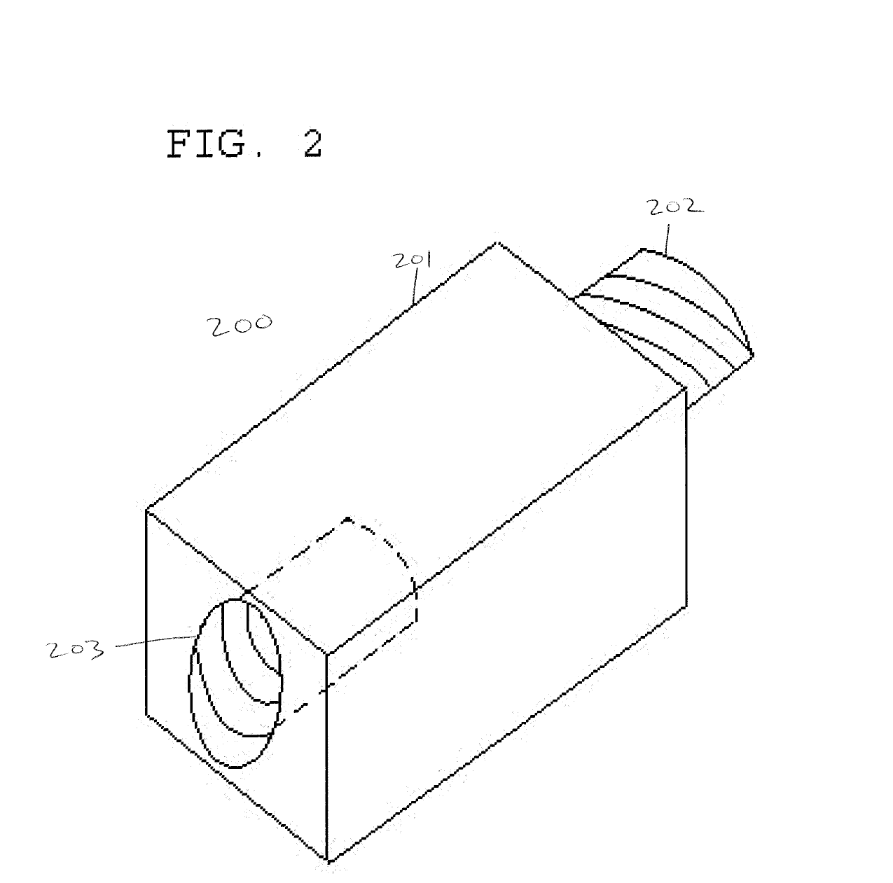

Referring to FIG. 2, depicted is a block according to the present invention. Block 200 comprises body 201, stud 202 and cavity 203. Stud 202 has a threaded surface. More specifically, stud 202 has an external thread, or helical ridge, around its exterior surface. The external thread allows the stud 202 to securely join with the cavity of another block. Cavity 203 comprises an internal thread around its interior surface. The internal thread allows the cavity 203 to securely join with the stud of another block. In an alternative embodiment, stud 202 may have an internal thread, and cavity 203 may have an external thread. Preferably, stud 202 and cavity 203 are substantially cylindrical, allowing for a smooth connection.

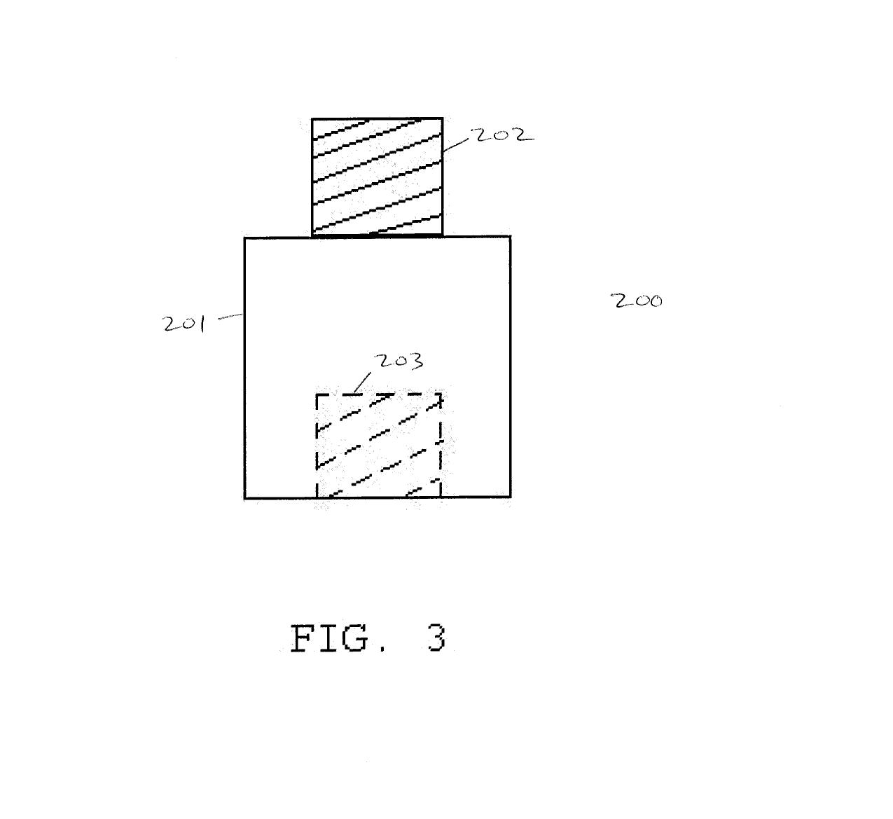

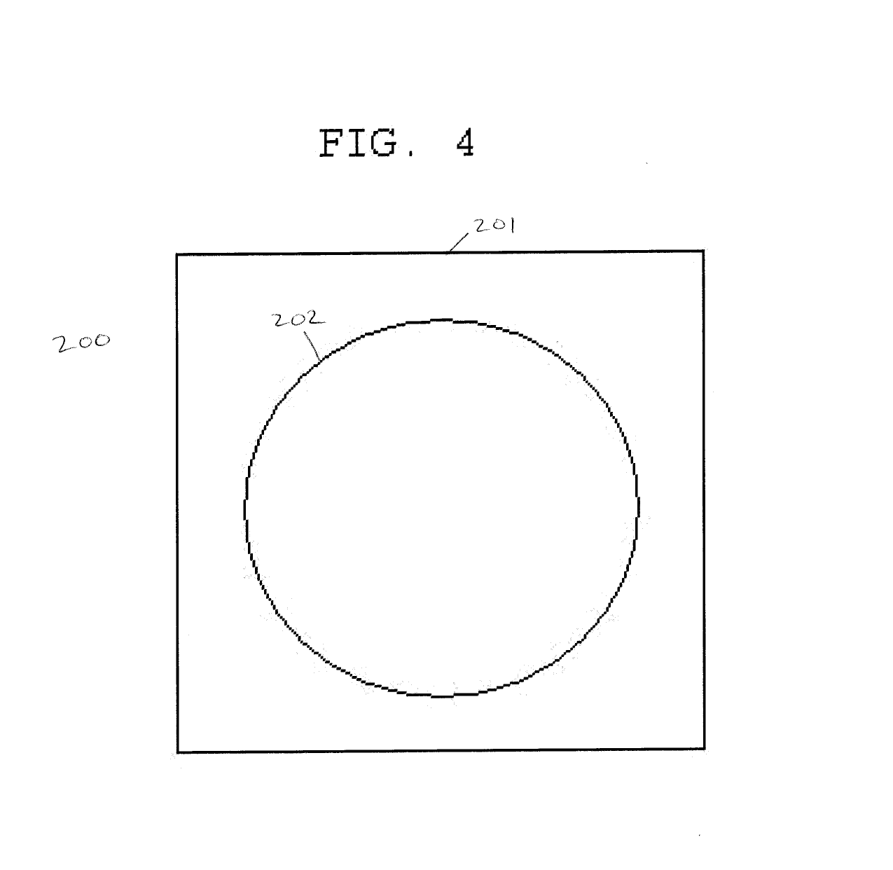

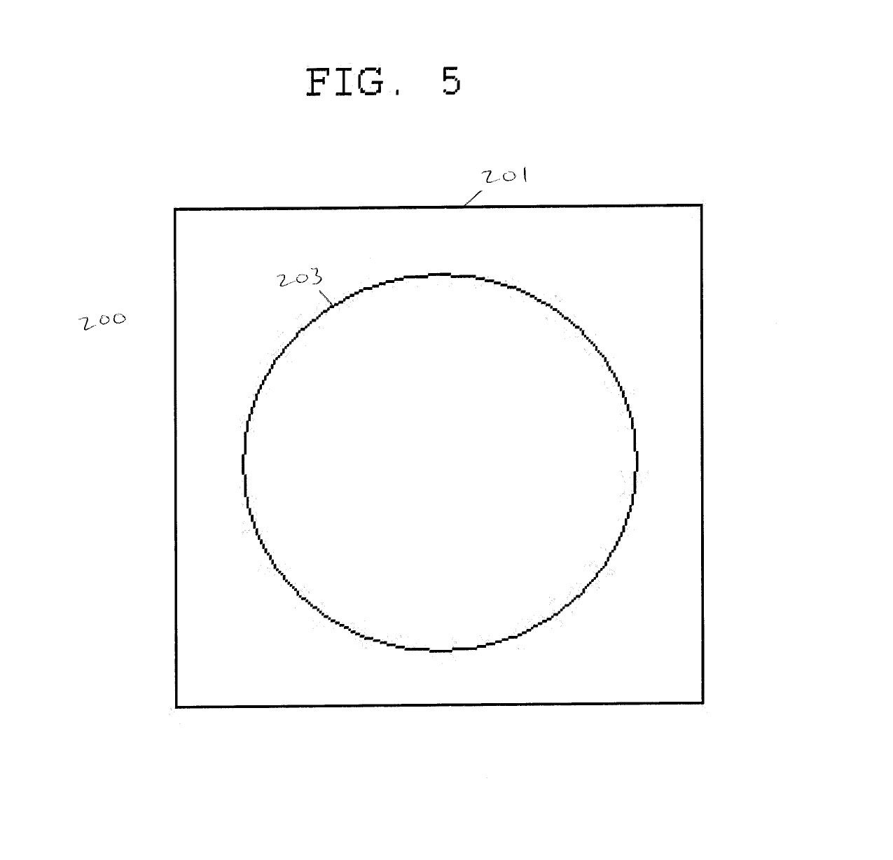

FIG. 3 depicts a side view of block 200. FIGS. 4 and 5 depict a top and bottom view, respectively, of block 200.

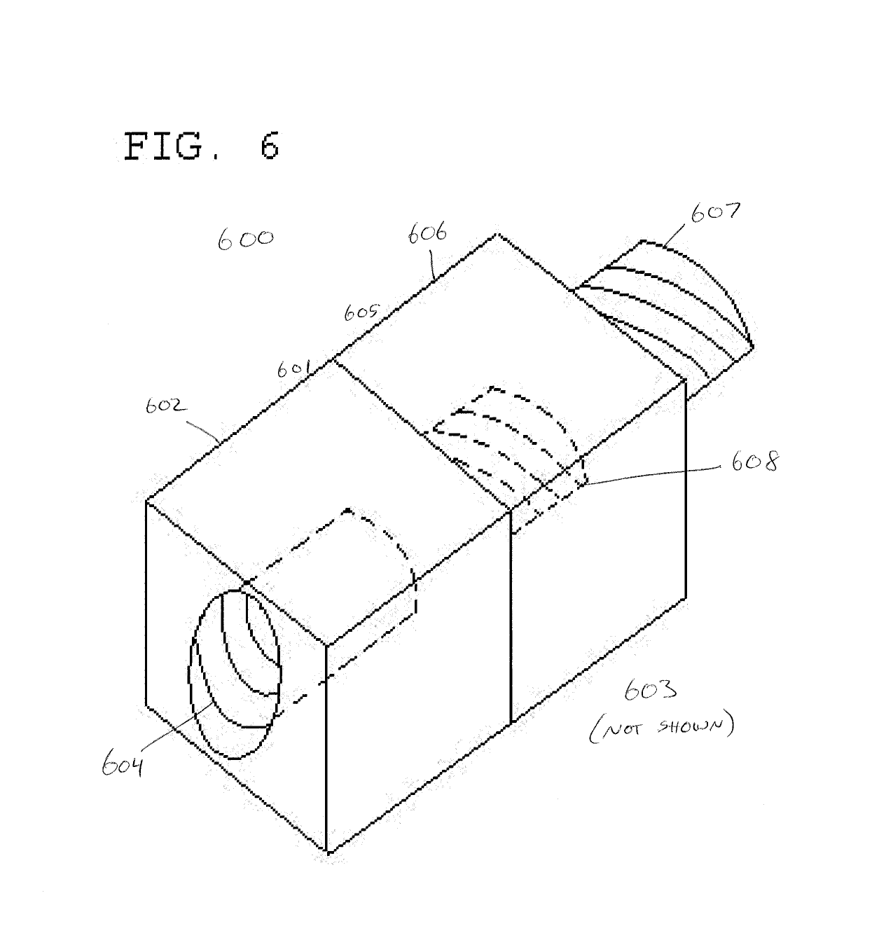

Referring to FIG. 6, structure 600 is formed when the stud 603 (not shown) of block 601 is inserted and rotated into the cavity 608 of block 605. Through this process, blocks 601 and 605 become securely joined. The resulting structure 600 is more stable than a structure comprised of prior art blocks such as block 100 of FIG. 1. For example, blocks of the present invention cannot be separated simply by pulling them apart.

Stud 607 is free to join with the cavity of another block, and cavity 604 is free to join with the stud of another block. Thus, multiple blocks may be joined together.

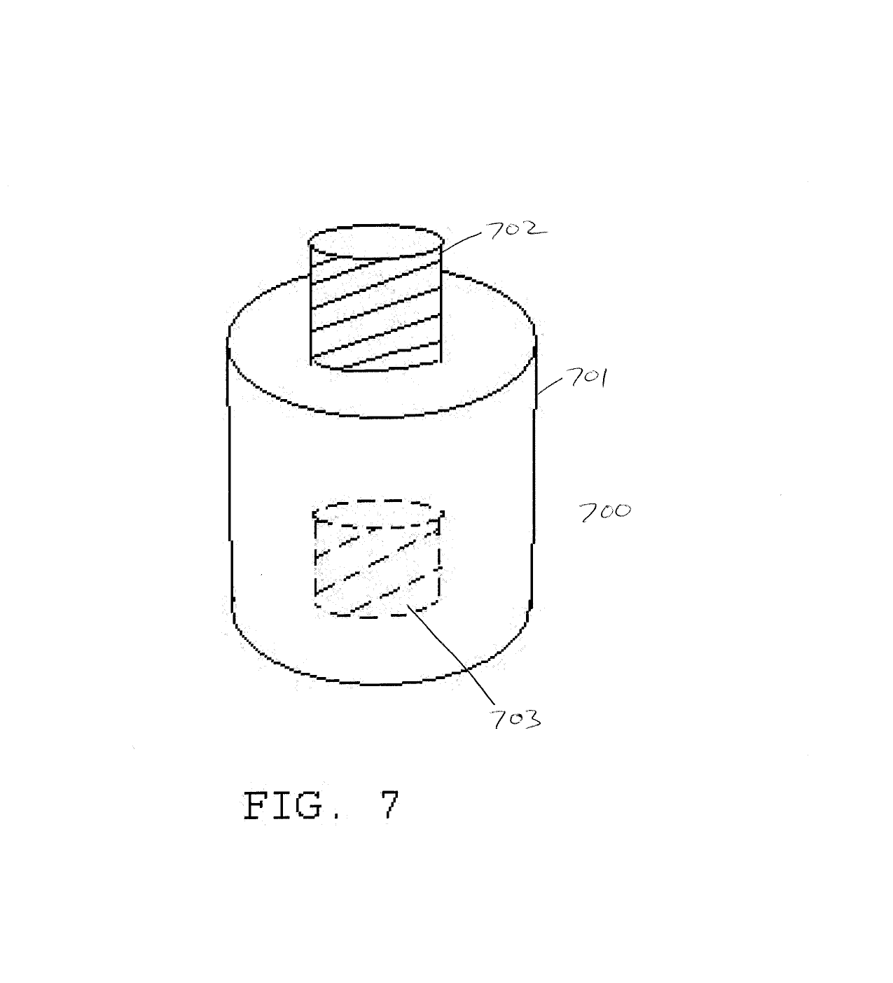

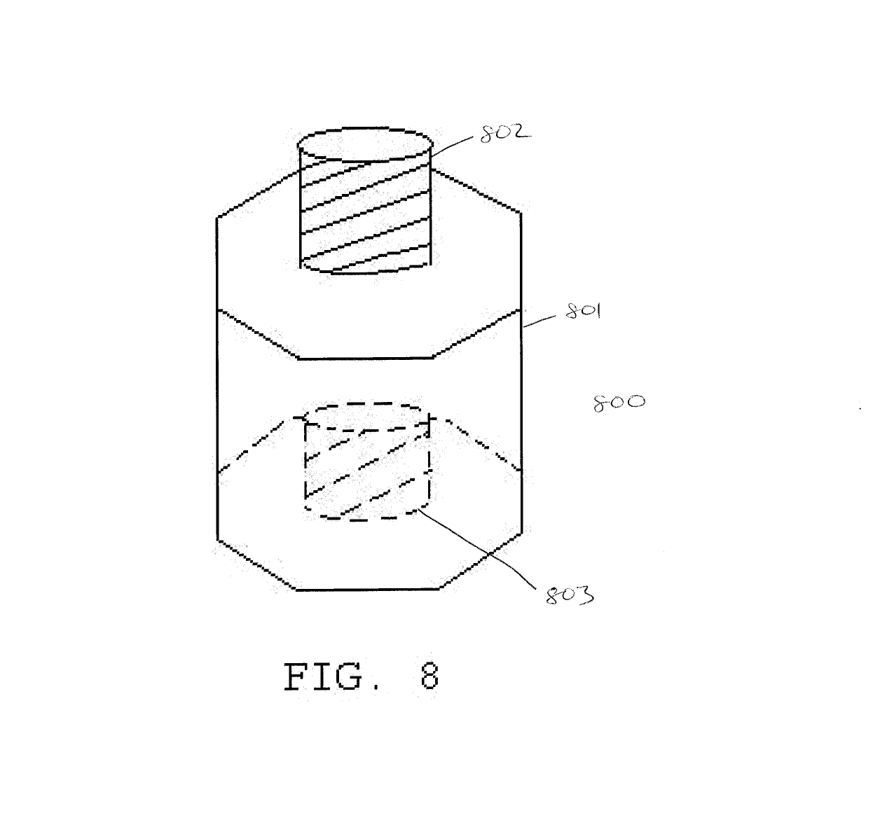

The block of the present invention may be constructed in any shape. For example, referring to FIG. 7, block 700 has round body 701. Stud 702 and cavity 703 are still capable of joining other blocks, thereby forming a structure with at least one round body component. Likewise, FIG. 8 depicts a block 800 with a hexagonal body 801. Stud 802 and cavity 803 are unaffected by the shape of the body, and may join with one or more blocks to form a structure with at least one hexagonal body component.

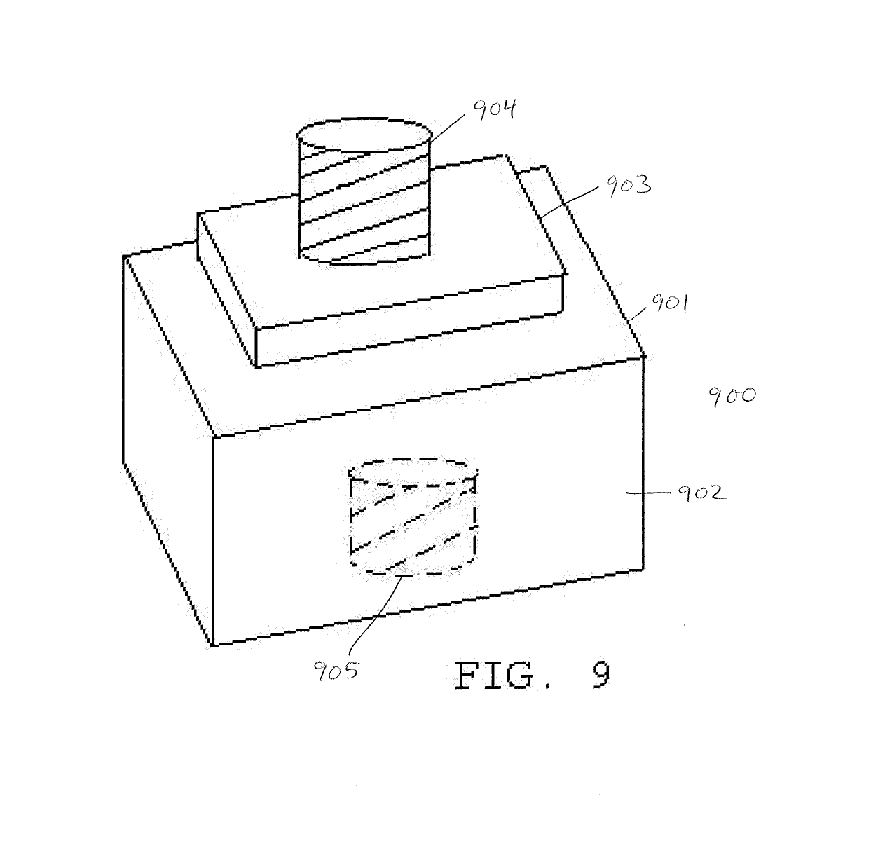

As should be apparent from the description above, each block comprises a stud, a body with one or more side surfaces, and a cavity. A block may comprise multiple shapes and surfaces, an example of which is depicted in FIG. 9. Block 900 comprises stud 902, cavity 903 and a body 901 featuring multiple surfaces.

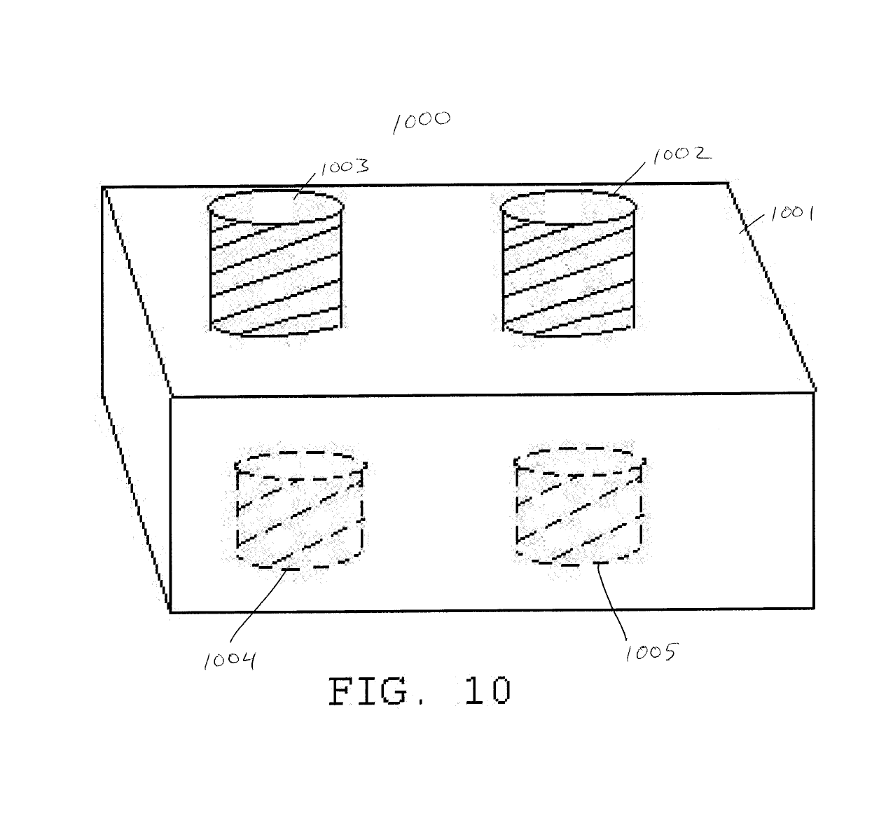

A block according to the present invention may have more than one stud. Similarly, a block may have more than one cavity. FIG. 10 depicts a block 1000 comprising two studs and two cavities. Specifically, block 1000 comprises body 1001, stud 1002, stud 1003, cavity 1004 and cavity 1005. Additional blocks may be joined to either or both studs 1002 and 1003 and/or either or both cavities 1004 and 1005 to form a structure. For example, stud 202 of block 200 may be joined with cavity 1004 of block 1000 to form a structure.

A block may comprise one or more studs without comprising a cavity. Alternatively, a block may comprise one or more cavities without comprising a stud.

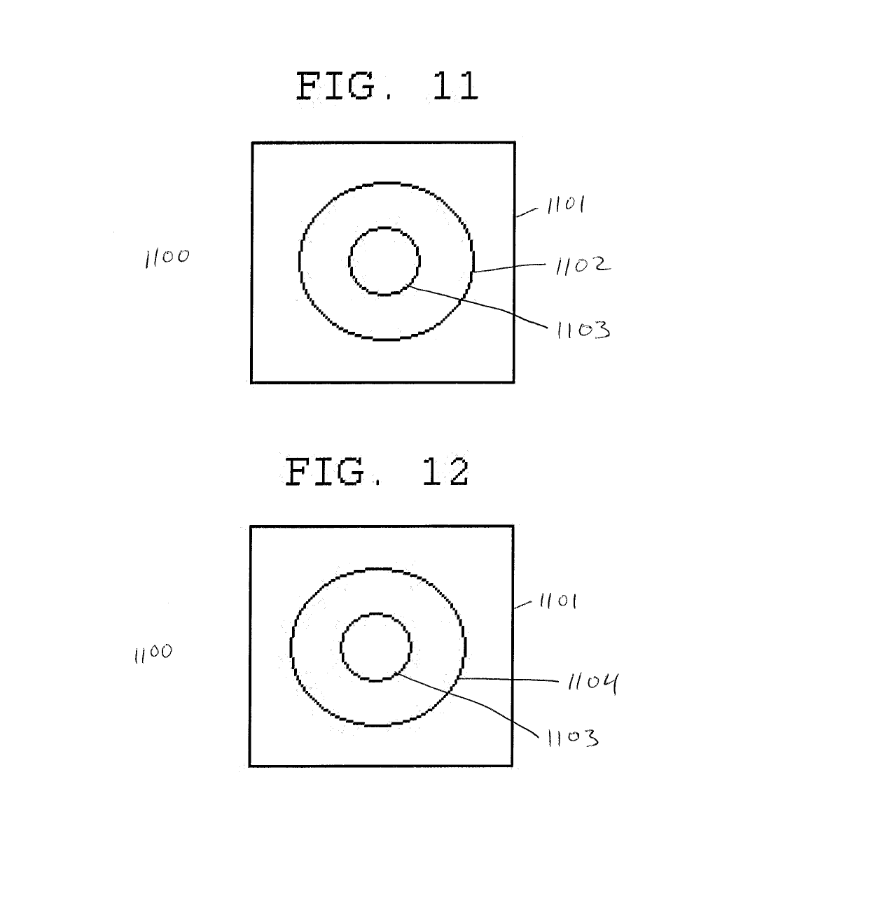

A block may be designed with a hole passing through it. FIG. 11 depicts a top view of block 1100 with body 1101 and stud 1102. A hole 1103 passes through stud 1102 and body 1101. FIG. 12 depicts a bottom view of block 1100. Again, hole 1103 passes through stud 1102 (not shown) and body 1101. By its nature, the hole passes through the top of cavity 1104.

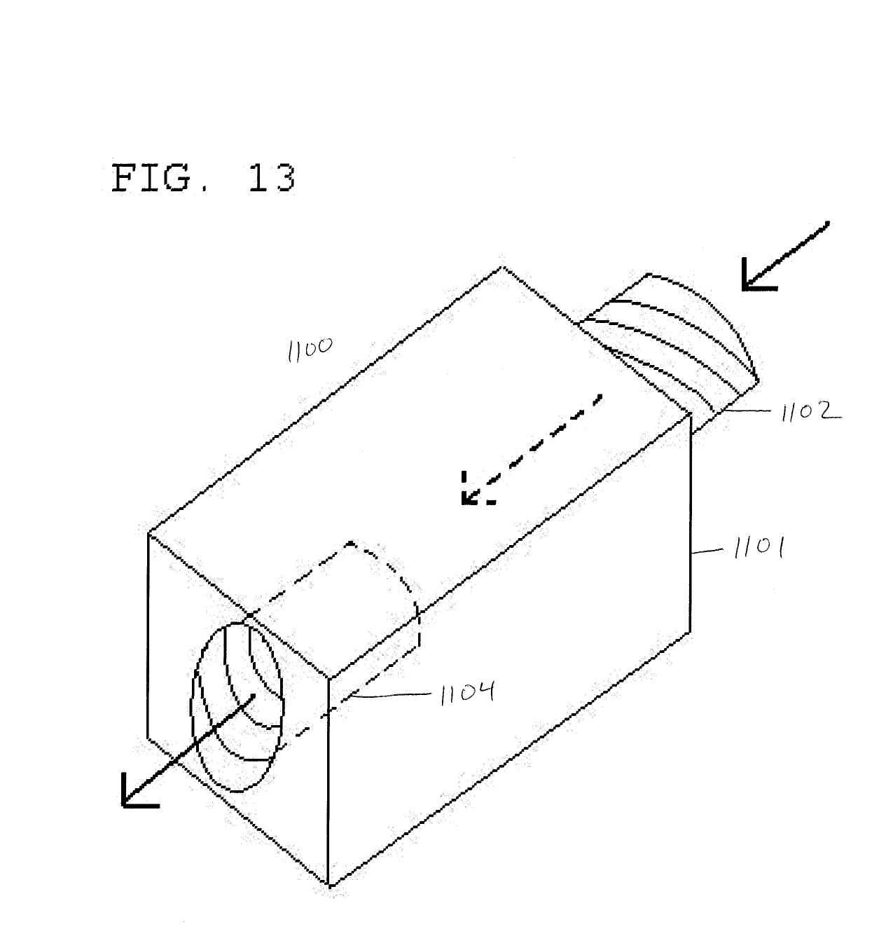

This configuration allows an object to pass through the block. For example, a rod could be placed through the center of one block or through the center of a structure of two or more joined blocks. Alternatively, a fluid such as water or sand could pass through the center of one block or through a structure of two or more joined blocks. Any object or fluid that passes through block 1100 of FIGS. 11-12 will pass through body 1101, stud 1102 and cavity 1104. A direction of flow through block 1100 is depicted in FIG. 13. Of course, any object or fluid may pass through in either direction or occupy the space inside the block indefinitely.

It should be appreciated that a hole need not pass through the center of the block. For example, a hole may be offset, pass through at an angle, pass through the side of the body of the block, curve or bend inside the block, or take on any other shape or direction. Multiple holes may pass through a block. It is also possible that a hole not pass entirely through the block. Instead, a recess may be disposed in the block by carving, drilling, molding or other method.

To separate two blocks that have been securely joined, one must rotate the blocks, releasing the stud of one block from the cavity of the other. The blocks of the present invention may be joined and separated repeatedly.

As mentioned earlier, the threaded surfaces of a stud or a cavity may be designed using either an external thread or an internal thread. In addition, the threaded surfaces of a stud or a cavity may be designed with either a right-hand thread or left-hand thread. The threaded surfaces of a stud or a cavity may be designed so that either clockwise rotation or counterclockwise rotation is necessary to securely join blocks together. In either case, rotation in the opposite direction will release the blocks, allowing them to be separated.

It will be noted that the block of the present invention may be constructed in any shape so long as it supports a stud and/or cavity. Also, the block of the present invention may be constructed of any suitable material without departing from the present invention.

It should be appreciated that the body of a block of the present invention may be substantially solid, substantially hollow, or any combination thereof, so long as the body supports at least one stud and/or at least one cavity.

In view of the foregoing, it will be readily understood that a structure of blocks of the present invention has an advantage of reversible connection and separation. In addition, a structure comprised of blocks of the present invention is secure because the threaded surfaces of studs and cavities interconnect with one another. The blocks of the present invention can be combined into a limitless combination of structures. Furthermore, the present invention has the advantages of simple construction and manufacturing.

The blocks of the present invention may be used as toys. It is believed that playing with the blocks of the present invention will improve the manual dexterity of a child.

The blocks of the present invention may comprise magnets or magnetic material. For example, referring to FIG. 2, stud 202 and/or body 201 may comprise magnetic material. In this way, the stud of one block may be magnetically attracted to, or repelled by, the body of another block.

It will thus be seen that the objects of the present invention set forth above, among other objects made apparent from the preceding description, are efficiently attained. Because certain changes may be made in the above constructions without departing from the spirit and scope of the invention, it is intended that all matter contained in the above description or shown in the accompanying drawings shall be interpreted as illustrative and not in a limiting sense.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

What is claimed is:

1. A unit comprising:
at least one body, comprising:
at least one stud comprising a threaded surface; and
at least one cavity comprising a threaded surface.

2. The unit of claim 1, wherein said stud comprises a right-hand threaded surface.

3. The unit of claim 1, wherein said stud comprises a left-hand threaded surface.

4. The unit of claim 1, wherein said body comprises at least a second stud comprising a threaded surface.

5. The unit of claim 1, wherein said body comprises at least a second cavity comprising a threaded surface.

6. The unit of claim 1, wherein said body is substantially cubical.

7. The unit of claim 1, wherein said body is substantially cylindrical.

8. The unit of claim 1, wherein said body is substantially hexagonal.

9. The unit of claim 1, wherein said body is partially hollow.

10. The unit of claim 1, wherein said stud comprises magnetic material.

11. The unit of claim 1, wherein said body comprises magnetic material.

12. The unit of claim 1, wherein at least one hole passes through said body.

13. A structure comprising:
a first unit comprising:
a first body, comprising:
a first stud comprising a threaded surface;
a first cavity comprising a threaded surface;
a second unit comprising:
a second body, comprising:
a second stud comprising a threaded surface; and
a second cavity comprising a threaded surface;
wherein said first unit and said second unit are coupled together.

14. The structure of claim 13, wherein said first stud is coupled to said second cavity.
